(19) United States
(12) Patent Application Publication
(10) Pub. No.: US 2026/0261202 A1
(43) Pub. Date: Sep. 3, 2026

(54) FAST DC LINK VOLTAGE CONTROL OF GRID-CONNECTED CONVERTERS MAINTAINING LOW TOTAL HARMONIC DISTORTION

(71) Applicant: B.G. NEGEV TECHNOLOGIES AND APPLICATIONS LTD., AT BEN-GURION UNIVERSITY, Beer Sheva (IL)

(72) Inventors: Alon KUPERMAN, Beer Sheva (IL); Pavel STRAJNIKOV, Ashdod (IL)

(21) Appl. No.: 18/873,437

(22) PCT Filed: Jun. 12, 2023
(86) PCT No.: PCT/IL2023/050603

§ 371 Date: Dec. 10, 2024

(30) Foreign Application Priority Data
Jun. 12, 2022 (EP) 22178551.2

(51) Int. Cl. H02M 1/42; H02J 3/01; H02M 1/12

(52) U.S. Cl. CPC H02M 1/4225; H02J 3/01; H02M 1/12; H02M 1/4233

(57) ABSTRACT

A grid-connected converter comprising a power factor controller (PFC) for control of flow of power from a grid supply to a load via a DC link, by switching of at least one active component, which converter including: a voltage controller receiving a link voltage v_{DC} at the DC link and generating a feedback control signal for input to the PFC controller from the link voltage, which voltage controller including: a notch filter tuned to a nominal grid frequency; and a proportional (P)+lead lag compensator.

### TECHNOLOGICAL FIELD

The present invention, in some embodiments, thereof, relates to grid-connected convertors and, more particularly, but not exclusively, to voltage controllers for grid connected convertors with active power factor correction (PFC), and design thereof.

### BACKGROUND ART

Background art, where each art is individually incorporated in its entirety by reference, includes the below list. In the following document these arts are referred to by number e.g. number in square brackets.
[1]M. G. Taul et al., “Current reference generation based on next-generation grid code requirements of grid-tied converters during asymmetrical faults,” IEEE J. Emerg. Sel. Top. Power Electron., vol. 8, no. 4, pp. 3784-3797, Dec. 2020.
[2]O. Garcia et al., “Single phase power factor correction: A survey,” IEEE Trans. Power Electron., vol. 18, no. 3, pp. 749-755, May 2003.
[3]B. Singh et al., “A review of single-phase improved power quality AC-DC converters,” IEEE Trans. Ind. Electron., vol. 50, no. 5, pp. 962-981, Oct. 2003.
[4]M. M. Jovanovic and Y. Jang, “State-of-the-art, single-phase, active powerfactor-correction techniques for high-power applications—An overview,” IEEE Trans. Ind. Electron., vol. 52, no. 3, pp. 701-708, Jun. 2005.
[5]B. Singh et al., “A review of three-phase improved power quality AC-DC converters,” IEEE Trans. Ind. Electron., vol. 51, no. 3, pp. 641-660, Jun. 2004.
[6]J. W. Kolar and T. Friedli, “The essence of three-phase PFC rectifier systems—Part I,” IEEE Trans. Power Electron., vol. 28, no. 1, pp. 176-198, Jan. 2013.
[7]J. W. Kolar, M. Hartmann and T. Friedli, “The essence of three-phase PFC rectifier systems—Part II,” IEEE Trans. Power Electron., vol. 29, no. 2, pp. 543-560, Feb. 2014.
[8]K. Yao, Y. Wang, J. Guo, and K. Chen, “Critical conduction mode boost PFC converter with fixed switching frequency control,” IEEE Trans. Power Electron., vol. 33, no. 8, pp. 6845-6857, Aug. 2018.
[9]J. Kim, H. Choi, and C. Y. Won, “New modulated carrier controlled PFC boost converter,” IEEE Trans. Power Electron., vol. 33, no. 6, pp. 4772-4782, Jun. 2018.
[10]H. S. Nair, and L. Narasama, “An improved digital algorithm for boost PFC converter operating in mixed conduction mode,” IEEE J. Emerg. Sel. Topics Power Electron., vol. 8, no. 4, pp. 4235-4245, Dec. 2020.
[11]A. Mallik, J. Lu, and A. Khaligh, “A comparative study between PI and type-II compensators for H-bridge PFC converter,” IEEE Trans. Ind. Appl., vol. 54, no. 2, pp. 1128-1135, Mar. 2018.
[12]J. Honkanen, H. Jarvisalo, T. J. Karkkainen and J. Korhonen, “Discussion of ‘A comparative study between PI and type-II compensators for H-bridge PFC converter’,” IEEE Trans. Ind. Appl., vol. 54, no. 4, pp. 4009, Jul. 2018.
[13]P. Strajnikov and A. Kuperman, “Guidelines for voltage controller coefficients design to attain prescribed grid current THD and DC link voltage undershoot values in power factor correction front ends,” IEEE J. Emerg. Sel. Top. Power Electron., DOI: 10.1109/JESTPE.2021.3100484.
[14]M. Karimi-Ghartemani, S. A. Khajehoddin, P. K. Jain and A. Bakhshari, “A systematic approach to DC-bus control design in single-phase grid-connected renewable converters,” IEEE Trans. Power Electron., vol. 28, no. 7, pp. 3158-3166, Jul. 2013.
[15]W. Huai and F. Blaabjerg, “Reliability of capacitors for DC-link applications in power electronic converters—An overview,” IEEE Trans. Ind. Appl., vol. 50, no. 5, pp. 3569-3578, Sep.-Oct. 2014.
[16]H. Wang, H. Wang, G. Zhu and F. Blaabjerg, “An overview of capacitive DC links: Topology derivation and scalability analysis,” IEEE Trans. Power Electron., vol. 35, no. 2, pp. 1805-1829, Jan. 2019.
[17]H. Wang and H. Wang, “Capacitive DC links in power electronic systems—reliability and circuit design,” Chinese Jour. Electr. Eng., vol. 4, no. 3, pp. 29-36, Sep. 2018.
[18]A. Mutovkin, V. Yuhimenko, S. Schacham and A. Kuperman, “Simple and straightforward realization of an electronic capacitor,” Electron. Lett., vol. 55, no. 4, pp. 220-222, Feb. 2019.
[19]A. Mutovkin et al., “Control of direct voltage regulated active DC link capacitance reduction circuits to allow plug-and-play operation,” IEEE Trans. Ind. Electron., vol. 66, no. 8, pp. 6527-6537, 2019.
[20]A. Mutovkin, V. Yuhimenko, S. Schacham and A. Kuperman, “Nonlinear control of electronic capacitor for enhanced stability and dynamic response,” IEEE Trans. Ind. Electron., vol. 68, no. 8, pp. 6881-6892, Aug. 2021.
[21]J. Sebastian et al., “On the maximum bandwidth attainable by power factor correctors with a standard compensator,” IEEE Trans. Ind. Appl., vol. 46, no. 4, pp. 1485-1497, Aug. 2010.
[22]R. Ghosh and G. Narayanan, “Generalized feed-forward control of singlephase PWM rectifiers using disturbance observes,” IEEE Trans. Ind. Electron., vol. 54, no. 2, pp. 984-954, Apr. 2007.
[23]E. Figures, J. M. Benavent, G. Garcera, and M. Pascual, “A control circuit with load-current injection for single-phase power-factor-correction rectifiers,” IEEE Trans. Ind. Electron., vol. 54, no. 3, pp. 1272-1282, Jun. 2007.
[24]K. Yao et al., “A scheme to improve power factor and dynamic response performance for CRM/DCM buck-buck/boost PFC converter,” IEEE Trans. Power Electron., vol. 36, no. 2, pp. 1828-1843, Feb. 2021.
[25]H.-C. Chiang et al., “Control method for improving the response of single-phase continuous conduction mode boost power factor correction rectifier,” IET Power Electron., vol. 9, no. 9, pp. 1792-1800, 2016.
[26]R. Pena-Alzola, M. A. Bianchi and M. Ordonez, “Control design of a PFC with harmonic mitigation function for small hybrid AC/DC buildings,” IEEE Trans. Power Electron., vol. 31, no. 9, pp. 6607-6620, Sep. 2016.
[27]K. H. Leung, K. H. Loo and Y. M. Lai, “Unity-power-factor control based on precise ripple cancellation for fast-response PFC preregulator,” IEEE Trans. Power Electron., vol. 31, no. 4, pp. 3324-3337, Apr. 2016.
[28]K. H. Leung, K. H. Loo and Y. M. Lai, “A family of ripple estimation-cancellation methods based on switched-resistor circuits and their application in fast-response PFC preregulator,” IEEE Trans. Power Electron., vol. 32, no. 4, pp. 2608-2621, Apr. 2017.
[29]S. Li, W. Lu, S. Yan and Z. Zhao, “Improving dynamic performance of boost PFC converter using current-harmonic feedforward compensation in synchronous reference frame,” IEEE Trans. Ind. Electron., vol. 67, no. 6, pp. 4857-4866, Jun. 2020.
[30]W. Lu, J. Han, S. Li and H. H.-C. Ju, “Mitigating line frequency instability of boost PFC converter under proportional outer-voltage loop with additional third current-harmonic feedforward compensation,” IEEE Trans. Circ. Syst.-I: Reg. Papers, vol. 66, no. 11, pp. 4528-4541, Nov. 2019.
[31]H. Luo, J. Xu, D. He and J. Sha, “Pulse train control strategy for CCM boost PFC converter with improved dynamic response and unity power factor,” IEEE Trans. Ind. Electron., vol. 67, no. 12, pp. 10377-10387, Dec. 2020.
[32]A. Kessal and L. Rahmani, “Analysis and design of sliding mode controller gains for boost power factor corrector,” ISA Trans., vol. 52, pp. 638-643, 2013.
[33]P. R. Mohanty and A. K. Panda, “Fixed-frequency sliding-mode control scheme based on current control manifold for improved dynamic performance of boost PFC converter,” IEEE J. Emerg. Sel. Top. Power Electron., vol. 5, no. 1, pp. 576-586, Mar. 2017.
[34]A. Bouafassa, L. Rahmani, A. Kessal and B. Babes, “Unity power factor converter based on a fuzzy controller and predictive input current,” ISA Trans., vol. 53, pp. 1817-1821, 2014.
[35]W. Ma et al., “Stabilizing the average-current-mode-controlled boost PFC converter via washout-filter-aided method,” IEEE Trans. Circ. Syst.-II: Exp. Briefs, vol. 58, no. 9, pp. 595-599, Sep. 2011.
[36]H. S. Nair and L. Narasamma, “Simple digital algorithm for improved performance in a boost PFC converter operating in CCM,” IET Power Electron., vol. 12, no.5, pp. 1102-1113, 2019.
[37]S. Buso, P. Mattavelli, L. Rossetto, G. Spiazzi, “Simple digital control improving dynamic performance of power factor preregulators,” IEEE Trans. Power Electron., vol. 13, no. 5, pp. 814-823, Sep. 1998.
[38]A. El Aroudi, A. Cid-Pastor and L. Martinez-Salamero, “Suppression of line frequency instabilities in PFC AC-DC power supplies by feedback notch filtering the pre-regulator output voltage,” IEEE Trans. Circ. Syst.-I: Reg. Papers, vol. 60, no. 3, pp. 796-809, Mar. 2013.
[39]S. A. Khajehoddin, M. Karimi-Ghartemani, P. K. Jain and A. Bakhshari, “DC-bus design and control for a single-phase grid-connected renewable converter with a small energy storage component,” IEEE Trans. Power Electron., vol. 28, no. 7, pp. 3245-3254, Jul. 2013.
[40]M. K. H. Cheung, M. H. L. Chow and C. K. Tse, “An analog implementation to improve load transient response of PFC pre-regulators,” in Proc. 29th IEEE Int. Telecom. Energy Conf., pp. 848-855, Rome, Italy, 2007.
[41]P. Strajnikov and A. Kuperman, “Selection of PI+Notch voltage controller coefficients to attain desired steady-state and transient performance in PFC rectifiers,” IEEE J. Emerg. Sel. Top. Power Electron., DOI: 10.1109/JESTPE.2021.3130990.
[42]R. W. Erickson and D. Maksimovic, Fundamentals of Power Electronics, Kluwer Academic, 2001.
[43]A. Mutovkin et al., “Conditions for direct applicability of electronic capacitors to dual-stage grid-connected power conversion systems,” IEEE J. Emerg. Sel. Top. Power Electron., vol. 7, no. 3, pp. 1805-1814, Mar. 2019.
[44] https://www.elspec-ltd.com/understanding-the-ieee-519-2014-standard-for-harmonics/
[45]P. Strajnikov and A. Kuperman, “On the minimum DC link capacitance in practical PFC rectifiers considering THD requirements and load transients,” IEEE Trans. Ind. Electron., DOI: 10.1109/TIE.2021.3118385.

Acknowledgement of the above references herein is not to be inferred as meaning that these are in any way relevant to the patentability of the presently disclosed subject matter.

### GENERAL DESCRIPTION

Following is a non-exclusive list of some exemplary embodiments of the invention. The invention also includes embodiments which include fewer than all the features in an example and embodiments using features from multiple examples, even if not expressly listed below.

Example 1. A grid-connected converter comprising a power factor controller (PFC) for control of flow of power from a grid supply to a load via a DC link, by switching of at least one active component, which converter comprising:
a voltage controller receiving a link voltage v_{DC} at said DC link and generating a feedback control signal for input to PFC controller from said link voltage, which voltage controller comprising:
   a notch filter tuned to a nominal grid frequency; and
a proportional (P)+lead lag compensator.

Example 2. The grid-connected converter according to Example 1, wherein coefficients of said notch filter and said P+lead lag compensator are selected to provide a selected total harmonic distortion (THD) of said grid supply.

Example 3. The grid-connected converter according to Example 2, wherein said coefficients are selected to provide said THD for a range of grid frequencies around said nominal grid frequency.

Example 4. The grid-connected convertor according to any one of Examples 1-3, wherein a frequency domain transfer function of said P+lead lag compensator includes a pole and a zero.

Example 5. The grid-connected converter according to any one of Examples 1-4, wherein said voltage controller is implemented according to a voltage controller transfer function, C_{V}(s):

$${C}_{V} ( s ) = K \frac{τ s + 1}{σ s + 1} \frac{{s}^{2} + 4 {ω}_{G}^{2}}{{s}^{2} + 4 {ξω}_{G} s + 4 {ω}_{G}^{2}}$$

where ω_{G} is said grid frequency, K is a constant for proportional control and K, ξ, and σ are selected to control total harmonic distortion (THD) of a grid power supply.

Example 6. The grid-connected convertor according to any one of Examples 4-5, wherein
said pole is located at the origin, K is non-zero, said compensator providing a proportional control term to said frequency domain transfer function.

Example 7. The grid-connected converter according to Example 6, wherein said controller is implemented, according to a controller transfer function, C_{V}(s):

$${C}_{V} ( s ) = K \frac{{s}^{2} + 4 {ω}_{G}^{2}}{{s}^{2} + 4 {ξω}_{G} s + 4 {ω}_{G}^{2}}$$

where ω_{G} is said grid frequency, K is a constant for proportional control and K and are selected to control total harmonic distortion (THD) of a grid power supply.

Example 8. The grid-connected converter according to any one of Examples 1-7, comprising a current controller which receives a signal i_{GM}* from said PFC controller and uses said signal from said PFC controller as a reference current to generate a control signal for switching of said at least one active component.

Example 9. The grid-connected convertor according to Example 8, comprising a pulse width modulator (PWM) which receives said control signal from said current controller and generates a drive signal for switching of said at least one active component.

Example 10. The voltage controller according to any one of Examples 1-9, wherein said link voltage is a voltage across a bulk DC link capacitance linking said convertor to a load.

Example 11. The grid-connected converter according to Example 10, wherein an input to said voltage controller comprises a difference between said DC link voltage and a reference voltage.

Example 12. The grid connected converter according to any one of Examples 1-11, comprising an additional notch filter tuned to an additional nominal grid frequency.

Example 13. The grid connected converter according to Example 12, wherein said nominal grid frequency is 50 Hz and said additionally nominal grid frequency is 60 Hz.

Example 14. The grid connected convertor according to any one of Examples 12-13, wherein said controller is implemented, according to a controller transfer function, C_{V} (s):

$${C}_{V} ( s ) = K \frac{{s}^{2} + 4 {ω}_{G 1 , nom}^{2}}{{s}^{2} + 4 {ξ}_{1} {ω}_{G 1 , nom} s + 4 {ω}_{G 1 , nom}^{2}} \frac{{s}^{2} + 4 {ω}_{G 2 , nom}^{2}}{{s}^{2} + 4 {ξ}_{2} {ω}_{G 2 , nom} s + 4 {ω}_{G2 , nom}^{2}} .$$

Example 15. The grid-connected converter according to any one of Examples 5-13, wherein said K and said ξ are selected to maintain said THD below a maximum allowed total harmonic distortion (THDᵢ*) and a minimum allowed phase margin (PM*).

Example 16. The grid-connected converter according to any one of Examples 11-14,
wherein said grid frequency (ω_{G}) varies between two limits ω_{G,min}<ω_{G}<ω_{G,max}; and
wherein K and ξ are determined using design equations:

$$2 {THD}_{i}^{*} = \frac{{V}_{GM} {KG}_{DC}}{4 {ω}_{G , min} \sqrt{1 + 4 {{ξ}^{2} ( \frac{{ω}_{G} {ω}_{G , min}}{{ω}_{G}^{2} - {ω}_{G , min}^{2}} )}^{2}}} ;$$

$${ω}_{V}^{2} + \frac{4 {ξω}_{G , nom}}{tan ( \frac{π}{2} - {PM}^{*} )} {ω}_{V} - 4 {ω}_{G , nom}^{2} = 0 ; and$$

$$\frac{\frac{{V}_{GM} {KG}_{DC}}{2 {ω}_{V}} ( 4 {ω}_{G}^{2} - {ω}_{V}^{2} )}{\sqrt{{( 4 {ω}_{G}^{2} - {ω}_{V}^{2} )}^{2} + {( 4 {ξω}_{G} {ω}_{V} )}^{2}}} = 1 ;$$

where ω_{V} is cross over angular frequency;
where V_{GM} is a steady state value of grid side input voltage; and
where

$${G}_{DC} = \frac{1}{{C}_{DC} {V}_{DC}^{*}}$$

where C_{DC} is a capacitance of said bulk link capacitor and V*_{DC} is said reference voltage.

Example 17. A system comprising a grid-connected converter according to any one of Examples 1-6, comprising a load interfacing convertor (LIC) connected between said DC link capacitance and said load.

Example 18. The system according to Example 17, wherein said load interfacing convertor is a DC-DC convertor.

Example 19. A computer implemented method for design of a voltage controller for a grid-connected converter comprising a power factor controller (PFC), wherein said method is implemented to allow a maximum total harmonic distortion (THDᵢ*) to a supply current, where said method comprises determining parameters K and ξ for a transfer function of said voltage controller:

$${C}_{V} ( s ) = K \frac{{s}^{2} + 4 {ω}_{G}^{2}}{{s}^{2} + 4 {ξω}_{G} s + 4 {ω}_{G}^{2}}$$

wherein said grid frequency (ω_{G}) varies between two allowed limits ω_{G,min}≤ω_{G}≤ω_{G,max}; and
wherein said determining of K and ξ is using design equations:

$$2 {THD}_{i}^{*} = \frac{{V}_{GM} {KG}_{DC}}{4 ω \sqrt{1 + 4 {{ξ}^{2} ( \frac{{ω}_{G , nom} {ω}_{G , min}}{{ω}_{G , nom}^{2} - {ω}_{G , min}^{2}} )}^{2}}} ;$$

$${ω}_{V}^{2} + \frac{4 ζ {ω}_{G , nom}}{tan ( \frac{π}{2} - {PM}^{*} )} {ω}_{V} - 4 {ω}_{G , nom}^{2} = 0 ; and$$

$$\frac{\frac{{V}_{GM} {KG}_{DC}}{2 {ω}_{V}} ( 4 {ω}_{G , nom}^{2} - {ω}_{V}^{2} )}{\sqrt{{( 4 {ω}_{G , nom}^{2} - {ω}_{V}^{2} )}^{2} + {( 4 {ξω}_{G , nom} {ω}_{V} )}^{2}}} = 1 .$$

Example 20. The method according to Example 19, comprising implementing a controller a power factor controller (PFC) according to said transfer function C_{V}(s), using said determined parameters K and ξ.

Example 21. A method of upgrading a grid-connected convertor connectable to a load by a DC link and having a PFC controller comprising:
adjusting an original voltage controller to include:
   a notch filter tuned to a nominal grid frequency; and
a lead lag compensator.

Example 22. The method according to Example 21, wherein said adjusting comprises removing said original voltage controller and replacing said original voltage controller with a controller comprising said notch filter and said lead lag compensator.

Example 23. The method according to Example 21, wherein said adjusting comprises adjusting software of a digitally implemented voltage controller.

Example 24. The method according to any one of Examples 21-23, wherein said adjusting comprises adding and/or replacing and/or removing passive circuit components.

Example 25. A method of upgrading a grid connected switched mode power supply (SMPS) converter having a PI or type-II voltage control loop, comprising:
removing an integrator from said voltage controller loop;
adjusting a coefficient K of a proportional convertor to control steady-state DC link voltage tracking error introduced by removal of said integrator.

Example 26. The method according to Example 25, wherein said grid connected SMPS converter comprises one or more notch filter.

Example 27. A method of upgrading a grid-connected convertor connectable to a load by a DC link and having a PFC controller comprising:
adjusting said PFC controller to notch filter a received signal.

Example 28. The method according to Example 27, comprising adjusting an original voltage controller to include a proportional compensator.

Example 29. The method according to Example 27, comprising adjusting an original voltage controller to include a proportional+lead lag compensator.

Example 30. The method according to Example 27, comprising adjusting an original voltage controller to include type-II compensator.

Example 31. A grid-connected converter comprising a power factor controller (PFC) for control of flow of power from a grid supply to a load via a DC link, by switching of at least one active component, which converter comprising:
a voltage controller receiving a link voltage v_{DC} at said DC link and generating a feedback control signal for input to PFC controller from said link voltage, which voltage controller comprising:
   a notch filter tuned to a nominal grid frequency; and
a proportional (P) compensator.

Example 32. The grid-connected converter according to Example 32, wherein said controller is implemented, according to a controller transfer function, C_{V}(s):

$${C}_{V} ( s ) = K \frac{{s}^{2} + 4 {ω}_{G}^{2}}{{s}^{2} + 4 {ξω}_{G} s + 4 {ω}_{G}^{2}}$$

where ω_{G} is said grid frequency, K is a constant for proportional control and K and ξ are selected to control total harmonic distortion (THD) of a grid power supply.

Unless otherwise defined, all technical and/or scientific terms used within this document have meaning as commonly understood by one of ordinary skill in the art/s to which the invention pertains. Methods and/or materials similar or equivalent to those described herein can be used in the practice and/or testing of embodiments of the invention, and exemplary methods and/or materials are described below. Regarding exemplary embodiments described below, the materials, methods, and examples are illustrative and are not intended to be necessarily limiting.

Some embodiments of the present invention are embodied as a system, method, or computer program product. For example, some embodiments of the invention may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the invention can involve performing and/or completing selected tasks manually, automatically, or a combination thereof. According to actual instrumentation and/or equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computational device e.g. using any suitable operating system.

In some embodiments, one or more tasks according to some exemplary embodiments of method and/or system as described herein are performed by a data processor, such as a computing platform for executing a plurality of instructions.

Optionally, the data processor includes a volatile memory for storing instructions and/or data and/or a non-volatile storage e.g. for storing instructions and/or data. Optionally, a network connection is provided as well. User interface/s e.g. display/s and/or user input device/s are optionally provided.

Some embodiments of the present invention may be described below with reference to flowchart illustrations and/or block diagrams. For example illustrating exemplary methods and/or apparatus (systems) and/or and computer program products according to embodiments of the invention. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g. in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g. on the computational device, other programmable apparatus and/or other devices to produce a computer implemented process such that the instructions which execute provide processes for implementing the functions/acts specified in the flowchart and/or block diagram block or blocks.

Some of the methods described herein are generally designed only for use by a computer, and may not be feasible and/or practical for performing purely manually, by a human expert. A human expert who wanted to manually perform similar tasks, might be expected to use different methods, e.g., making use of expert knowledge and/or the pattern recognition capabilities of the human brain, potentially more efficient than manually going through the steps of the methods described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a simplified schematic of a dual-stage grid-connected AC/DC power conversion system, according to some embodiments of the disclosure;

FIG. 2 is a simplified schematic of a dual-stage grid connected AC/DC power conversion system, according to some embodiments of the disclosure;

FIG. 3 is a method of feedback control for a convertor, according to some embodiments of the disclosure;

FIG. 4 is a detailed method of feedback control for a convertor, according to some embodiments of the disclosure;

FIG. 5 is a simplified schematic block diagram of a closed-loop-controlled power conversion system, according to some embodiments of the disclosure;

FIG. 6 is a simplified schematic small-signal representation block diagram of a power conversion system, according to some embodiments of the disclosure;

FIG. 7A is a Bode phase plot of phase with frequency for a DC link voltage loop gain, according to some embodiment of the disclosure;

FIG. 7B is a Bode magnitude plot of gain magnitude with frequency for a DC link voltage loop gain, according to some embodiment of the disclosure;

FIG. 7C is an enlarged portion of FIG. 7B showing magnitude for frequencies between 2ω_{G,min}<ω<2ω_{G,max} with ω_{G,min}=2π·49.5 [rad/s] and ω_{G,max}=2π·50.5 [rad/s];

FIG. 8 is a simplified schematic of a grid-connected convertor (GIC), according to some embodiments of the disclosure;

FIG. 9 is a simplified schematic of a grid-connected convertor (GIC), according to some embodiments of the disclosure;

FIG. 10A illustrates a simulated system response to rated load application and removal for grid frequency of 2π·49.5 [rad/s], according to some embodiments of the disclosure;

FIG. 10B illustrates a simulation system response to rated load application and removal for grid frequency of 2π·50 [rad/s], according to some embodiments of the disclosure; and

FIG. 10C illustrates a simulation system response to rated load application and removal for grid frequency of 2π·50.5 [rad/s], according to some embodiments of the disclosure;

FIG. 11 is a simplified schematic block diagram of a power conversion system, according to some embodiments of the disclosure; and

FIGS. 12A-C are simplified schematic illustrations of analog voltage control circuitry, according to some embodiments of the disclosure.

### DETAILED DESCRIPTION OF EMBODIMENTS

### Overview

A broad aspect of some embodiments of the disclosure relates to control of an AC/DC grid-connected convertor (GIC) connectable to a source or load by a DC link, where control is of total harmonic distortion (THD) to the grid supply and of a possible speed of change in a voltage v_{DC} at the DC link (e.g. for a given link capacitance). Where, in some embodiments, without control, changes in load power consumption and/or source power generation which cause rapid changes to v_{DC} result in large amounts of harmonic distortion of the grid current.

In some embodiments, power exchange with the grid is controlled (e.g. indirectly) by a voltage controller. Where, in some embodiments, the GIC includes one or more active component, the switching of which (controlled by the voltage controller), over time, determines power exchange with the grid through the convertor.

An aspect of some embodiments of the disclosure relates to a voltage controller for a voltage control loop of a GIC convertor including a notch filter/s and a lead-lag regulator, herein termed a “lead-lag+notch” voltage controller. Where, within this document, terms “regulator” “controller” and “voltage controller” are used interchangeably.

Where, in some embodiments, the voltage controller is part of a voltage control feedback loop, having a voltage at the DC link as an input.

In some embodiments, the voltage controller provides an input to a power factor correcting (PFC) controller. In some embodiments, the PFC controller generates a control signal for control of switching of active component/s (e.g. via a pulse width modulator PWM which receives the control signal and drives the switching) which control flow of power between the grid and the load or source (e.g. via loading a DC link capacitor at the DC link). Optionally, a current controller receives the PFC control signal, implementing another current control loop, before the signal is used for control of switching (e.g. via the PWM).

In some embodiments, the lead-lag regulator is simplified to a proportional type (P-type) regulator to give a “P+Notch” voltage controller. In some embodiments, the controller is designable to maintain THD below a maximum allowed value. A potential advantage of such controllers lacking an integration term, is increased voltage loop bandwidth e.g. for a given maximal THD.

Where the voltage controller lacks an integrator term, for example, according to non-binding modelling described and/or illustrated within this document, the GIC loop gain has a single integrator term.

This is in comparison to traditional type-II or PI regulator controllers which have, according to modelling as described within this document, a system loop gain having a double integrator, as provided by combination of the integration term of the voltage controller with a system integration term. Where, without wanting to be bound by theory, it is theorized that double integrator within the loop gain transfer function produces zero steady state tracking error of the DC link voltage.

In some embodiments, the notch filter portion of the voltage controller (e.g. without an integrator term) is sufficient to maintain THD within allowable limits. For example, where a notch filter coefficients are selected to provide desired THD (e.g. for one or more other given constraints).

An aspect of some embodiments of the disclosure relates to allowing some steady state tracking error in v_{DC} to allow increased speed of change in DC link voltage (also herein termed “voltage loop bandwidth”). Where, in some embodiments, an allowed steady state tracking error is up to 2.5%, or up to 5%, or up to 1%, or lower or higher or intermediate percentages where, in some embodiments, the percentage is of the steady state voltage.

In some embodiments, effect of removing an integrator term on steady state error to the output voltage is compensated by increasing the proportional coefficient (K) of the controller (e.g. for both lead-lag+notch and P+notch controllers). Where increasing K is possible, in some embodiments, by virtue of the single integrator term (e.g. as opposed to where the system transfer function includes a double integrator).

In some embodiments, models as described in this document of the convertor include analytical expression/s, where the analytical expression/s are used in selection of coefficient/s (e.g. via a computer aided method) for the controller notch filter and/or lead-lag regulator. In some embodiments, coefficient/s are selected based on one or more of; desired maximally allowed total harmonic distortion (THD), grid voltage frequency, variation in grid voltage frequency, and controller element/s (e.g. a value of bulk capacitance linking the convertor to a load).

An aspect of some embodiments of the disclosure relates to a computer aided method of controller design for determining coefficient/s for a voltage loop controller.

Where, in some embodiments, one or more portion of the voltage loop controller is implemented digitally, the controller being implemented e.g. by an IC having the determined coefficients. Where, in some embodiments, one or more portion of the voltage loop controller is implemented using passive components. Where passive component controller design (e.g. value/s for the passive components) is, in some embodiments, performed by a processor as a computer aided method.

A broad aspect of some embodiments of the disclosure relates to upgrading of an existing convertor structure and/or product. For example, by maintaining an initial design of the convertor while adjusting a voltage controller portion. For example, by incorporating functionality of one or more portion (e.g. notch filtering) of a voltage controller within a PMC where in some embodiments, a voltage controller portion is adjusted, in some embodiments, the voltage controller is not adjusted, the PMC is programmed to compensate for a portion of the voltage controller.

In some embodiments, the upgrade includes removal and/or adjustment of (e.g. coefficients of) a regulator e.g. to change the regulator from type-II or PI to lead-lag. In some embodiments, e.g. where the initial design of the controller includes a notch filter, the coefficients are upgraded. In some embodiments, where the initial design of the controller lacks a notch filter, a notch filter is added e.g. at voltage controller circuitry e.g. at a PMC chip.

In some embodiments, the upgrading includes changing code for digital implementation of portion/s forming the voltage controller. Additionally, or alternatively, in some embodiments, upgrading includes checking suitability of and/or changing and/or removing component/s (e.g. passive components of a notch filter) of one or more portion of the existing controller.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Without wanting to be bound by theory, it is generally assumed that a trade-off exists between DC link voltage dynamics and AC-side current quality in grid-connected converters limiting attainable DC link voltage loop bandwidth, potentially imposing a need for bulk DC-link capacitors.

For example, as in reference [41], it has been shown that adding a notch filter in series with the typically employed PI or type-II regulator allows improving of DC link voltage dynamics without sacrificing total harmonic distortion (THD). However, PI and type-II regulators contain integrator terms, which potentially eliminate steady state error but contribute negative phase potentially limiting attainable dynamic performance.

In some embodiments, active power factor correction technique/s are utilized in single-phase [2], [3], [4] and/or three-phase AC/DC power conversion systems, for example, to comply with grid power quality standards regulations.

Where, for single-phase AC/DC power conversion technique/s, in some embodiments, include one or more feature as disclosed in one or more of references [2], [3], and [4]. Where, for three-phase AC/DC power conversion technique/s, in some embodiments, include one or more feature as disclosed in one or more of references [5], [6], and [7].

In some embodiments, bridge convertors are used as PFC rectifiers. In some embodiments, bridgeless boost converters are adopted as PFC rectifiers. Where, in some embodiments, a PFC rectifier includes one or more feature of rectifiers disclosed in one or more of references [8], [9], and [10].

In some embodiments, a DC link voltage of a boost PFC rectifier is regulated utilizing a single voltage control loop (e.g. where the rectifier is operated in a DCM-only operation mode).

In some embodiments, a dual control loop including a current control loop and a voltage control loop (e.g. where the rectifier is operated in continuous conduction operation mode (CCM) and/or mixed continuous and discontinuous conduction operation mode (CCM/DCM)).

In some embodiments, for example, for both single and dual control loop rectifiers, the control loop/s employ PI or type-II regulators. For example, employing a regulator including one or more feature of regulators disclosed in one or more of references [11], [12] and [13].

In embodiments including a current loop, in some embodiments, the current loop bandwidth is potentially high. For example, the current loop bandwidth being limited by switching and/or sampling frequency.

However, in some embodiments, voltage control loops have low (e.g. 5-10 Hz bandwidth, theorized as associated with a trade-off with the maximum allowed grid-current THD (e.g. as described in reference [14]), typically imposed by power quality standards (e.g. IEC 61000 or IEEE 519).

In some embodiments, large DC link capacitors are used to compensate for the response speed of the voltage loop e.g. to maintain the DC link voltage above grid voltage magnitude. For example, during a worst-case step-like load increase e.g. to retain boost converter controllability. Generally, the ability to increase DC link capacitance is limited in terms of reliability and/or physical size (e.g. as described in references [15]-[17]).

In some embodiments, active DC links (e.g. electronic DC links) are employed to reduce the amount of physical DC link capacitance e.g. by active power decoupling (e.g. as described in references [18]-[20]).

Voltage controllers as described in this document, in some embodiments, are employed with systems employing either passive or active DC links.

Without wanting to be bound by theory, it has been theorized that feedback of low-frequency DC link voltage ripple component (present upon unity power factor operation) contributes to the trade-off between AC-side current THD and DC link voltage dynamics.

In some embodiments, line voltage and/or load current feedforward is utilized to provide fast compensation against parameter variations without actually increasing the voltage loop bandwidth (e.g. as described in references [21]-[24]). Where, in some embodiments, the feedforward involves use of addition sensors.

Alternatively or additionally, in some embodiments, ripple estimation and/or cancellation techniques are used (e.g. as described in references [24]-[30]). Alternatively or additionally, in some embodiments, nonlinear and/or time-varying control approaches, using microcontrollers for implementation, are used e.g. as described in references[31]-[34].

In some embodiments, linear filter-based approaches (e.g. described in references [35]-[40]) are used. In some embodiments, notch-filter-based voltage regulators, are realized digitally (e.g. as described in reference [39]) and/or by an analog network (e.g. as described in reference [40]). In some embodiments, quantitative design guidelines for PI+N controller coefficients selection as described in reference [41] for CCM operating boost PFC converters are used and/or adapted in some embodiments.

### Exemplary Grid-Connected Power Conversion System

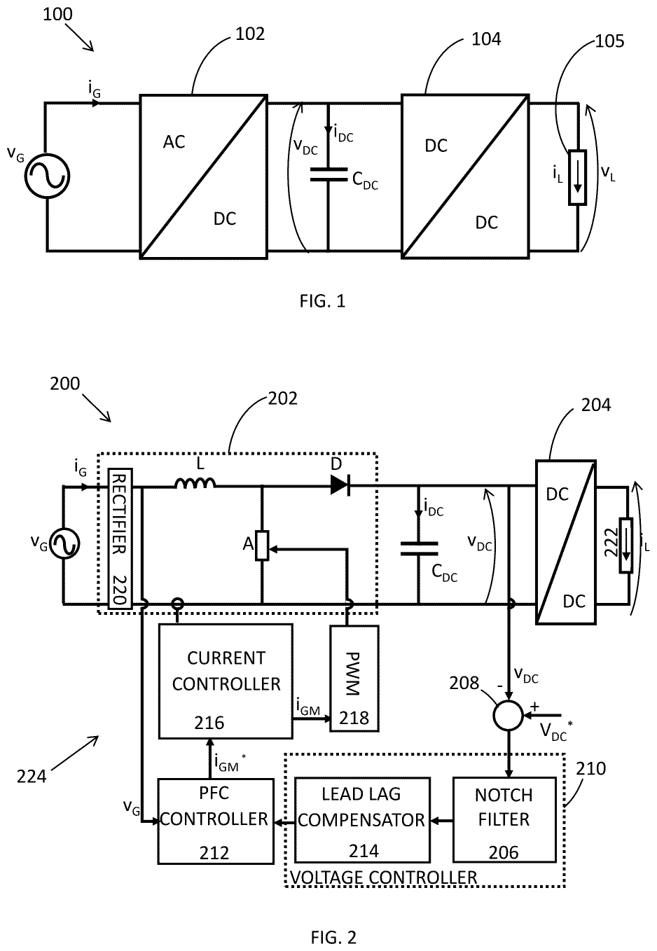

FIG. 1 is a simplified schematic of a dual-stage grid-connected AC/DC power conversion system 100, according to some embodiments of the disclosure.

In some embodiments, a dual-stage off-grid AC/DC power conversion system 100 includes a first stage, a grid-interfacing converter (GIC) 102 (also herein termed “power factor correcting rectifier” (PFCR), and second stage, a load-interfacing converter (LIC) 104 (also herein termed “load-interfacing downstream converter” (DSC). Alternatively or additionally, in some embodiments, the second stage 104 is a source-interfacing convertor (SIC). For example, in a case where the load 105 generates instead of consuming power (for all or some of the time). For ease of discussion, this document generally refers to a load which consumes power, however it should be understood that embodiments are applicable to a power generating load e.g. a “source” type load.

In some embodiments, a bulk DC link capacitance C_{DC} is located at the connection or “link” between GIC 102 and LIC 104. Where voltage at the link, the DC link voltage, is termed v_{DC} and where DC link current is termed i_{DC}.

Both converters 102, 104, in some embodiments, are assumed to be ideal (e.g. in terms of power efficiency) in the subsequent discussion.

FIG. 2 is a simplified schematic of a dual-stage grid connected AC/DC power conversion system 200 including power factor correction (PFC), according to some embodiments of the disclosure.

In some embodiments, grid power inputs v_{G} and i_{G} are connected to an AC/DC GIC 202 which is linked to a load 222 by a bulk capacitance C_{DC}. Optionally, in some embodiments, a DC/DC convertor 204 connects bulk capacitance C_{DC} to load 222.

In some embodiments, convertor 202 is a switched mode power supply (SMPS) convertor including one or more active component, A, and control circuitry 224. Where, in some embodiments, switching of active component/s A is controlled by control circuitry 224.

In FIG. 2, convertor 202 is illustrated as being a single boost convertor having a single active component A, an inductor L and a diode D. Where, in some embodiments, diode D is replaced by a different active component and/or component/s e.g. a transistor.

However, it should be understood that control circuitry 224 and/or controllers as described in this document are suitable for use with any convertor topologies (buck, buck-boost and their derivatives) of where generated control signal/s are used to drive switching of active component/s.

In some embodiments, control circuitry 224 includes a voltage feedback loop where output voltage v_{DC} is used in generation of a signal for driving of switching of active component/s A of convertor 202.

In some embodiments, a voltage controller 210 includes a notch filter 206 tuned to one or more expected (or “nominal”) grid frequencies and a lead-lag compensator 214. Where, in some embodiments, a nominal grid frequency is an expected frequency of the grid, e.g. as specified per country and/or per electrical supplier. In some embodiments, a nominal grid frequency is an average frequency that the supply has over a time period (e.g. as measured) for example. Where, in some embodiments, an error (e.g. an output of comparator 208) between a DC link voltage v_{DC} and a reference voltage V_{D}C is an input to voltage controller 210.

In some embodiments, voltage controller 210 generates, using its inputs, an output signal which provides a basis for control of switching of active component/s A. For example, where, in some embodiments, voltage controller 210 outputs a signal received by a PFC controller 212, where, based on this signal, the PFC controller generates a current i_{GM}*. Which, current i_{GM}*, in some embodiments, provides a reference current for a current controller 216 which, in some embodiments, provides an input to a pulse width modifier (PWM) 218. Where pulse modifier drives switching of active component/s A of convertor 202, pulse width modulation being based, in some embodiments, on the received control signal i_{GM}.

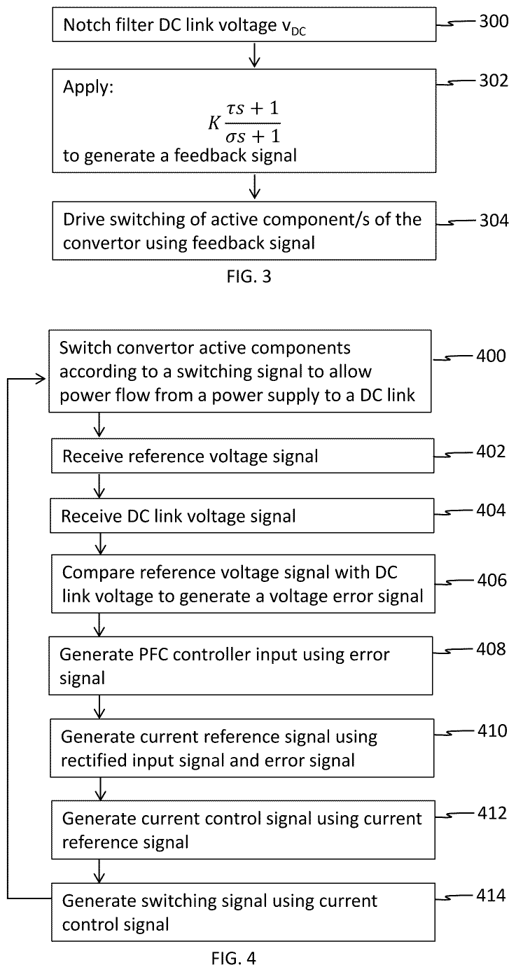

FIG. 3 is a method of feedback control for a convertor, according to some embodiments of the disclosure.

At 300, in some embodiments, a DC link voltage v_{DC} is notch filtered. For example, referring to FIG. 2, v_{DC} is notch filtered by notch filter 206.

At 302, for example, by a lead lag compensator 214 FIG. 2, in some embodiments, the below transfer function is applied to the notch filtered signal, to generate a feedback signal.

$$K \frac{τ s + 1}{σ s + 1}$$

At 304, in some embodiments, switching of active component/s (e.g. referring to FIG. 2 active component A) of the converter is driven using the feedback signal. Optionally, in some embodiments, the feedback signal is passed through a current feedback loop prior to being used for switching of the active component/s.

FIG. 4 is a detailed method of feedback control for a convertor, according to some embodiments of the disclosure.

At 400, in some embodiments, convertor active components are switched according to a switching signal to allow power flow from a power supply to a DC link.

At 402, in some embodiments, a reference voltage signal is received (e.g. V_{DC}* FIG. 2).

At 404, in some embodiments, a DC link voltage signal is received (e.g. v_{DC} FIG. 2).

At 406, in some embodiments, the reference voltage signal is compared with DC the link voltage to generate a voltage error signal (e.g. by comparator 208 FIG. 2).

At 408, in some embodiments, a PFC controller input is generated using the voltage error signal (e.g. voltage controller 210 FIG. 2).

At 410, in some embodiments, a current reference signal is generated using a rectified input signal and an error signal (e.g. by PFC controller 216 FIG. 2).

At 412, in some embodiments, a current control signal is generated using a current reference signal (e.g. by current controller 216 FIG. 2).

At 414, in some embodiments, a switching signal (e.g. supplied to step 400 in a loop) is generated using the current control signal (e.g. by PWM 218 FIG. 2).

### Exemplary Modeling of Exemplary Power System

FIG. 5 is a simplified schematic block diagram of a closed-loop-controlled power conversion system 500, according to some embodiments of the disclosure.

Where, in some embodiments, system 500 includes a voltage loop plant 502 (

Voltage loop plant 502, in some embodiments, is controlled via a dedicated (voltage) loop regulating the DC link voltage v_{DC} to a set point value

$${V}_{DC}^{*}$$

using controller C_{V}(s) 512 as loop compensator.

Where, voltage loop regulation includes comparison of v_{DC} (e.g. at a summer 511) with set point value V

$${V}_{DC}^{*}$$

(e.g. including subtraction), the error signal forming an input to the voltage controller C_{V}(s) 512.

In some embodiments, controller C_{V}(s) 512 produces a desired grid-side current magnitude

$${i}_{GM}^{*} ( t ) .$$

Where, in some embodiments,

$${i}_{GM}^{*} ( t )$$

is then multiplied by a unity-grid-voltage template sin(ω_{G}t) (or its rectified version |sin(ω_{G}t)|) to create a grid-side current reference

$${i}_{G}^{*} ( t )$$

(or its rectified version

$$\vert {i}_{G}^{*} ( t ) \vert ) .$$

Where grid-side current reference

$${i}_{G}^{*} ( t )$$

(or its rectified version

$$\vert {i}_{G}^{*} ( t ) \vert )$$

is, in some embodiments, tracked by an inner current loop, Tᵢ(s).

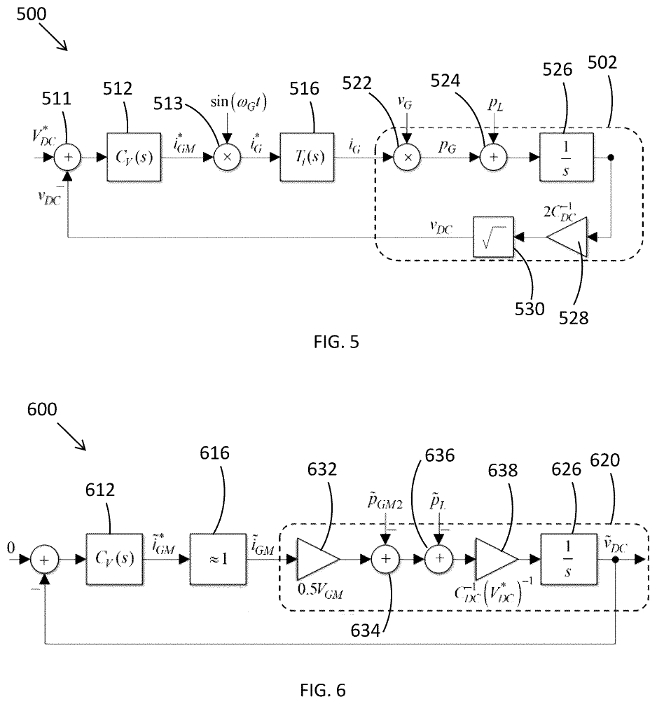

In some embodiments, current loop bandwidth is sufficiently high compared to DC link voltage bandwidth that complementary sensitivity of the current loop Tᵢ(s) 516 is, in some embodiments, assumed to be unity within DC link voltage bandwidth, e.g. as shown in FIG. 6.

In some embodiments, grid-side voltage and current are described by:

$${v}_{G} ( t ) = {\underbrace{{v}_{GM} ( t ) sin ( {ω}_{G} t )}}_{{v}_{1} ( t )} + {\underbrace{{\sum }_{n > 1} {V}_{n} sin ( n {ω}_{G} t )}}_{{ϕ}_{v} ( t )} [ V ] \qquad ( 1 )$$

$${i}_{G} ( t ) = {\underbrace{{i}_{GM} ( t ) sin ( {ω}_{G} t )}}_{{i}_{1} ( t )} + {\underbrace{{\sum }_{n > 1} {V}_{n} sin ( n {ω}_{G} t )}}_{{ϕ}_{i} ( t )} [ A ] ,$$

Where ω_{G} [rad/s] signifies grid frequency, ν_{GM}(t), i_{GM}(t) represent slow-varying (constant in steady-state) voltage and current magnitudes, respectively, and φ_{ν}(t), φᵢ(t) denote residual harmonic content.

In some embodiments, (for example, based on reference [43]) it is assumed that:

$$\sqrt{{\sum }_{n > 1} {V}_{n}^{2}} ≪ {V}_{GM}^{2} , \sqrt{{\sum }_{n > 1} {I}_{n}^{2}} ≪ {I}_{G M}^{2} \qquad ( 2 )$$

Where V_{GM}, I_{GM} indicate steady-state values of V_{GM}(t), i_{GM}(t), respectively.

Instantaneous grid power, in some embodiments, is then given by:

$$\begin{matrix}{p}_{G} ( t ) = {v}_{G} ( t ) {i}_{G} ( t ) \\ = {v}_{1} ( t ) {i}_{1} ( t ) + {v}_{1} ( t ) {ϕ}_{i} ( t ) + {i}_{1} ( t ) {ϕ}_{v} ( t ) + {ϕ}_{v} ( t ) {ϕ}_{i} ( t ) \\ = {\underbrace{0.5 {v}_{GM} ( t ) {i}_{G M} ( t )}}_{{p}_{GM} ( t )} ( 1 - cos ( 2 {ω}_{G} t ) ) + \\ {\underbrace{{ϕ}_{v} ( t ) {i}_{GM} ( t ) sin ( {ω}_{G} t ) + {ϕ}_{i} ( t ) {v}_{GM} ( t ) sin ( {ω}_{G} t ) + {ϕ}_{v} ( t ) {ϕ}_{i} ( t )}}_{{ϕ}_{p} ( t )} \\ = {p}_{GM} ( t ) + {\underbrace{( - {p}_{GM} ( t ) cos ( 2 {ω}_{G} t ) )}}_{Δ {p}_{G} ( t )} + {ϕ}_{p} ( t ) [ W ] ,\end{matrix} \qquad ( 3 )$$

Where p_{GM}(t) denotes slow-varying (constant in steady state) average power, Δp_{G}(t) represents low-frequency content of a pulsating (zero average) power component and φₚ(t) denotes residual harmonic content of the pulsating power component.

Symbolizing load-side instantaneous power as:

$${p}_{L} ( t ) = {v}_{L} ( t ) {i}_{L} ( t ) [ W ] \qquad ( 4 )$$

Assuming there are no power losses, link power p_{D}C is equal to input power P_{G} plus load power p_{L}:

$${p}_{DC} ( t ) = {v}_{DC} ( t ) {i}_{DC} ( t ) = {p}_{G} ( t ) + {p}_{L} ( t ) = {p}_{GM} ( t ) + {p}_{L} ( t ) + Δ {p}_{G} ( t ) + {ϕ}_{p} ( t ) . \qquad ( 5 )$$

Referring back to (2), in some embodiments, it is assumed that the root-mean-square value of φₚ(t) is much lower than that of Δp_{G}(t) and the former is neglected hereinafter in this document.

### Exemplary Steady-State Performance

In steady state, it is assumed that load-side instantaneous power p_{L}(t) is constant:

$${p}_{GM} ( t ) = {P}_{GM} = {P}_{L} = {p}_{L} ( t ) \qquad ( 6 )$$

In some embodiments, it is assumed that load-side voltage and current grid size voltage and current are constant (e.g. as well load-side instantaneous power):

$${V}_{GM} ( t ) = {V}_{GM} , {i}_{GM} ( t ) = {I}_{GM} = \frac{2 {P}_{L}}{{V}_{GM}} . \qquad ( 7 )$$

Steady-state instantaneous DC link voltage, in some embodiments, is then given by:

$${v}_{DC}^{ss} ( t ) = {V}_{DC}^{*} \sqrt[1]{- \frac{{P}_{L}}{{{ω}_{G} ( {V}_{DC}^{*} )}^{2} {C}_{DC}} sin ( 2 {ω}_{G} t )} . \qquad ( 8 )$$

In some embodiments, it is assumed that the DC link ripple magnitude is much lower than a corresponding set point:

$$\frac{{P}_{L}}{{{ω}_{G} ( {V}_{DC}^{*} )}^{2} {C}_{DC}} ≪ 1 \qquad ( 9 )$$

For example, according to reference [25], and using (9), (8) reduces to:

$${v}_{DC}^{ss} ( t ) \approx {V}_{DC}^{*} - \frac{{P}_{L}}{{\underbrace{2 {ω}_{G} {V}_{DC}^{*} {C}_{DC}}}_{Δ {V}_{DC}}} sin ( 2 {ω}_{G} t ) . \qquad ( 10 )$$

In some embodiments, using (7), (10) and FIG. 5, steady-state grid current magnitude is:

$${i}_{GM}^{ss} ( t ) \approx \frac{2 {P}_{L}}{{V}_{GM}} - Δ {V}_{DC} \vert {C}_{V} ( 2 {ω}_{G} ) \vert sin ( 2 {ω}_{G} t + arg {C}_{V} ( 2 {ω}_{G} ) ) \qquad ( 11 )$$

Where, in some embodiments, a steady-stage grid-side current is given by:

$${i}_{G}^{ss} ( t ) \approx {i}_{GM}^{ss} ( t ) sin ( {ω}_{G} t ) = \frac{2 {P}_{L}}{{V}_{GM}} sin ( {ω}_{G} t ) - \frac{Δ {V}_{DC} \vert {C}_{V} ( 2 {ω}_{G} ) \vert}{2} \times \times ( cos ( {ω}_{G} t + arg {C}_{V} ( 2 {ω}_{G} ) ) - cos ( 3 {ω}_{G} t + arg {C}_{V} ( 2 {ω}_{G} ) ) ) . \qquad ( 12 )$$

In some embodiments, it is assumed that the following holds:

$$\frac{Δ {V}_{DC} \vert {C}_{V} ( 2 {ω}_{G} ) \vert}{4} ≪ \frac{{P}_{L}}{{V}_{GM}} , \qquad ( 13 )$$

In some embodiments, using (13) and (10), grid-side current THD is given by:

$${THD}_{i} ≅ \frac{Δ {V}_{DC} \vert {C}_{V} ( 2 {ω}_{G} ) \vert}{\frac{4 {P}_{L}}{{V}_{GM}}} = \frac{{V}_{GM}}{8 {ω}_{G} {V}_{DC}^{*} {C}_{DC}} \vert {C}_{V} ( 2 {ω}_{G} ) \vert . \qquad ( 14 )$$

### Exemplary Transient Performance

Rewriting (5) as:

$${C}_{DC} \frac{{dv}_{DC} ( t )}{dt} {v}_{DC} ( t ) = 0.5 {v}_{GM} ( t ) {i}_{GM} ( t ) - {p}_{L} ( t ) + Δ {p}_{G} ( t ) , \qquad ( 15 )$$

perturbing the variables as:

$${v}_{DC} ( t ) = {V}_{DC} + {\tilde{v}}_{DC} ( t ) , {v}_{GM} ( t ) = {V}_{GM} + {\tilde{v}}_{GM} ( t ) , \qquad ( 16 )$$

$${i}_{GM} ( t ) = {I}_{GM} + {\tilde{i}}_{GM} ( t ) , {p}_{L} ( t ) = {P}_{L} + {\tilde{p}}_{L} ( t ) ,$$

$${p}_{G} ( t ) = {P}_{L} - {\underbrace{0.5 ( {V}_{GM} {\tilde{i}}_{GM} ( t ) + {I}_{GM} {\tilde{v}}_{GM} ( t ) )}}_{{\tilde{p}}_{GM} ( t )}$$

and linearizing around DC operation point (7) yields:

$$\frac{d {\tilde{v}}_{DC} ( t )}{dt} = {G}_{DC} \times ( \frac{{V}_{GM} {\tilde{i}}_{GM} ( t ) + {I}_{GM} {\tilde{v}}_{GM} ( t )}{2} - {\tilde{p}}_{L} ( t ) - {\tilde{p}}_{GM} ( t ) cos ( 2 {ω}_{G} t ) ) , \qquad ( 17 )$$

$${G}_{DC} = \frac{1}{{C}_{DC} {V}_{DC}^{*}} .$$

In some embodiments, it is assumed that, grid voltage magnitude variations are infrequent and slow, leading to an approximation that:

$${\tilde{v}}_{GM} ( t ) = 0 \qquad ( 18 )$$

FIG. 6 is a simplified schematic small-signal representation block diagram of a power conversion system 600, according to some embodiments of the disclosure.

In some embodiments, FIG. 6 is a small signal representation of linearized DC link voltage loop plant of FIG. 5.

Based on FIG. 6, loop gain is:

$${L}_{V} ( s ) = \frac{{V}_{GM}}{2} {G}_{DC} \frac{{C}_{V} ( s )}{s} . \qquad ( 19 )$$

In is interesting to note (e.g. referring back to equation (14)) that

$${THD}_{i} = \frac{\vert {L}_{V} ( 2 {ω}_{G} ) \vert}{2} , \qquad ( 20 )$$

Where, equation (20) shows that grid-side current total harmonic distortion THDᵢ, in some embodiments, is determined by voltage loop gain magnitude at double-grid frequency |LV(2ω_{G})|.

Regarding the structure of controller C_{V}(s), a general form for a type-II regulator+a notch filter is:

$${C}_{V} ( s ) = \frac{K}{s} \frac{τ s + 1}{σ s + 1} \frac{{s}^{2} + 4 {ω}_{G}^{2}}{{s}^{2} + 4 {ξω}_{G} s + 4 {ω}_{G}^{2}} \qquad ( 21 )$$

with 0≤ξ≤1 and σ<τ.

For ξ=0, (21) reduces to a type-II controller structure (e.g. according to references [12], and [13]):

$${C}_{V} ( s ) = \frac{K}{s} \frac{τ s + 1}{σ s + 1} \qquad ( 21 a )$$

For ξ=0, and σ=0, (21) is further simplified to a PI controller structure (e.g. according to reference [14]).

$${C}_{V} ( s ) = \frac{K ( τ s + 1 )}{s} \qquad ( 21 b )$$

For σ=0 and ξ≠0, (21) is a PI+Notch structure (e.g. according to reference/s [38], [39], [40], and [41]).

$${C}_{V} ( s ) = \frac{K ( τ s + 1 )}{s} \frac{{s}^{2} + 4 {ω}_{G}^{2}}{{s}^{2} + 4 {ξω}_{G} s + 4 {ω}_{G}^{2}} \qquad ( 21 c )$$

Combining (21) with (19) and FIG. 6 provides DC link voltage loop gain, Lᵥ(s), and disturbance-to-output,

$$\frac{{\tilde{v}}_{DC} ( s )}{{\tilde{p}}_{L} ( s )} ,$$

transfer functions given by:

$${L}_{V} ( s ) = \frac{{V}_{GM}}{2} {KG}_{DC} \frac{( τ s + 1 ) ( {s}^{2} + 4 {ω}_{G}^{2} )}{{s}^{2} ( σ s + 1 ) ( {s}^{2} + 4 {ξω}_{G} s + 4 {ω}_{G}^{2} )} \qquad ( 22 )$$

$$and$$

$$\frac{{\tilde{v}}_{DC} ( s )}{{\tilde{p}}_{L} ( s )} = \frac{{\tilde{v}}_{DC} ( s )}{{\tilde{p}}_{GM 2} ( s )} = \frac{- {G}_{DC}}{s} \cdot \frac{1}{1 + {L}_{V} ( s )} = \frac{- {G}_{DC} s ( σ s + 1 ) ( {s}^{2} + 4 ξ {ω}_{G} s + 4 {ω}_{G}^{2} )}{{s}^{2} ( σ s + 1 ) ( {s}^{2} + 4 ξ {ω}_{G} s + 4 {ω}_{G}^{2} ) + \frac{{V}_{GM} K ( τ s + 1 ) ( {s}^{2} + 4 {ω}_{G}^{2} )}{2 {G}_{DC}^{- 1}}} , \qquad ( 23 )$$

Observing (22) and (23), in some embodiments, it is theorized (without wanting to be bound by theory) that a notch filter component of (21) contributes to a low magnitude of the loop gain around a double-grid frequency (2ω_{G}). Which low gain at double-grid frequency potentially reduces THD e.g. to where it is at a sufficiently low level to comply with regulations for THD e.g. for current convertor implementations using type-II, or PI, or PI+notch regulators.

In equation (22), loop gain Lᵥ(s) includes a double integrator, which, it is theorized, contributes to zero steady-state tracking error for a step-like disturbance (e.g. referring to equation (23)).

A double integrator imposes a −180° loop gain phase asymptote, potentially limiting the attainable DC link bandwidth (and e.g. limits the value of K in (21) e.g. for stability).

In some embodiments, controller C_{V}(s) 512 is implemented without the integrator from (21), giving (24). Where resulting loop gain has a single integrator, associated with non-zero steady-state DC link voltage tracking error. Which is, in some embodiments, is tolerated as a trade-off for increased DC link voltage loop bandwidth. Potentially improving a disturbance rejection capability of the system.

$${C}_{V} ( s ) = K \frac{τ s + 1}{σ s + 1} \frac{{s}^{2} + 4 {ω}_{G}^{2}}{{s}^{2} + 4 {ξω}_{G} s + 4 {ω}_{G}^{2}} . \qquad ( 24 )$$

For ξ=0, (24) reduces to a P+lead lag controller structure:

$${C}_{V} ( s ) = K \frac{τ s + 1}{σ s + 1} \qquad ( 24 a )$$

For σ=0, (24) is further simplified to a P controller structure:

$${C}_{V} ( s ) = K \qquad ( 24 b )$$

For σ=τ and ξ, (24) is further simplified to a P+notch controller structure:

$${C}_{V} ( s ) = K \frac{{s}^{2} + 4 {ω}_{G}^{2}}{{s}^{2} + 4 {ξω}_{G} s + 4 {ω}_{G}^{2}} . \qquad ( 24 c )$$

Combining (24) with (19) and FIG. 6 to provide DC link voltage loop gain Lᵥ(s), and disturbance-to-output,

$$\frac{{\tilde{v}}_{DC} ( s )}{{\tilde{p}}_{L} ( s )} ,$$

transfer functions given by:

$${L}_{V} ( s ) = \frac{{V}_{GM}}{2} {KG}_{DC} \frac{( τ s + 1 ) ( {s}^{2} + 4 {ω}_{G}^{2} )}{s ( σ s + 1 ) ( {s}^{2} + 4 {ξω}_{G} s + 4 {ω}_{G}^{2} )} \qquad ( 25 )$$

$$and$$

$$\frac{{\tilde{v}}_{DC} ( s )}{{\tilde{p}}_{L} ( s )} = \frac{{\tilde{v}}_{DC} ( s )}{{\tilde{p}}_{GM 2} ( s )} = \frac{- {G}_{DC}}{s} \cdot \frac{1}{1 + {L}_{V} ( s )} = \frac{- {G}_{DC} ( σ s + 1 ) ( {s}^{2} + 4 ξ {ω}_{G} s + 4 {ω}_{G}^{2} )}{s ( σ s + 1 ) ( {s}^{2} + 4 ξ {ω}_{G} s + 4 {ω}_{G}^{2} ) + \frac{{V}_{GM} K ( τ s + 1 ) ( {s}^{2} + 4 {ω}_{G}^{2} )}{2 {G}_{DC}^{- 1}}} , \qquad ( 26 )$$

Observing (25) and (26), it is theorized (without wanting to be bound by theory) that a notch filter component of (24) maintains THD at required levels. However, the loop gain (25) includes now a single integrator, implying nonzero steady-state tracking error for a step-like load power variation p_{L}(t)=ΔP_{L}u(t) (e.g. referring to equation (26)), given by:

$${\tilde{v}}_{DC} ( t \to ∞ ) = \frac{2 Δ {P}_{L}}{{V}_{GM} K} . \qquad ( 27 )$$

On the other hand, single integrator imposes a −90° loop gain phase asymptote, imposing no limit on attainable DC link bandwidth. In some embodiments, K in (24) is increased to decrease the steady-state tracking error (27).

A particular two-parameter case of (24) is attained by setting σ=τ=0 as

$${C}_{V} ( s ) = K \frac{{s}^{2} + 4 {ω}_{G}^{2}}{{s}^{2} + 4 ξ {ω}_{G} s + 4 {ω}_{G}^{2}} , \qquad ( 28 )$$

Herein termed a “P+Notch” structure, for which a transfer function for loop gain is:

$${L}_{V} ( s ) = \frac{{V}_{GM}}{2} {KG}_{DC} \frac{{s}^{2} + 4 {ω}_{G}^{2}}{s ( {s}^{2} + 4 ξ {ω}_{G} s + 4 {ω}_{G}^{2} )} \qquad ( 29 )$$

And a transfer function for disturbance-to-output is:

$$\frac{{\tilde{v}}_{DC} ( s )}{{\tilde{p}}_{L} ( s )} = \frac{{\tilde{v}}_{DC} ( s )}{{\tilde{p}}_{GM 2} ( s )} = \frac{- {G}_{DC}}{s} \cdot \frac{1}{1 + {L}_{V} ( s )} = \frac{- {G}_{DC} ( {s}^{2} + 4 ξ {ω}_{G} s + 4 {ω}_{G}^{2} )}{{s}^{3} + ( 4 ξ {ω}_{G} + \frac{{V}_{GM}}{2} {KG}_{DC} ) {s}^{2} + 4 {ω}_{G}^{2} s + 4 {ω}_{G}^{2} \frac{{V}_{GM}}{2} {KG}_{DC}} , \qquad ( 30 )$$

In some embodiments, it is approximated that the below relation holds:

$$ξ ≪ \frac{2 {ω}_{G}}{{KV}_{GM} {G}_{DC}} \qquad ( 31 )$$

Based on (31), (30) reduces to

$$\frac{{\tilde{v}}_{DC} ( s )}{{\tilde{p}}_{L} ( s )} \approx \frac{- {G}_{DC}}{s + \frac{{V}_{GM}}{2} {KG}_{DC}} . \qquad ( 32 )$$

Based on (32), a step-like load power variation ΔP_{L} leads to DC link voltage perturbation given, in the Laplace domain, by:

$${\tilde{v}}_{DC} ( s ) = - {G}_{DC} Δ {P}_{L} \frac{1}{{s}^{2} + \frac{{V}_{GM}}{2} {KG}_{DC} s} \qquad ( 33 )$$

And in the time domain by:

$${\tilde{v}}_{DC} ( t ) = - \frac{2 Δ {P}_{L}}{{V}_{GM} K} ( 1 - exp ( - \frac{{V}_{GM}}{2} {KG}_{DC} t ) ) u ( t ) \qquad ( 34 )$$

Modelling of (33) and (34), shows that a first-order transient characterizes the response e.g. potentially without experiencing any oscillations and/or undershoot e.g. when assumption (31) holds. For example, in contrast to systems employing controllers having an integrator.

In some embodiments, a worst-case step-like load power increase is defined as a zero load—to—full load transition. To give, maximum DC link voltage perturbation imposed by the step-like load power increase in a P_{R}-rated system:

$$max \vert {\tilde{v}}_{DC} ( t ) \vert = \frac{2 {P}_{R}}{{V}_{GM} K} , \qquad ( 35 )$$

In some embodiments, using (35), an approximation is made to provide an expected average value of DC link voltage under full loading:

$${V}_{DC} \approx {V}_{DC}^{*} - max \vert {\tilde{v}}_{DC} ( t ) \vert = {V}_{DC}^{*} - \frac{2 {P}_{R}}{{V}_{GM} K} . \qquad ( 36 )$$

Taking into account the pulsating voltage component magnitude ΔV in (10), instantaneous DC link voltage under full loading would be given by:

$${v}_{DC}^{ss} ( t ) \approx {\underbrace{{V}_{DC}^{*} - \frac{2 {P}_{R}}{{V}_{GM} K}}}_{{V}_{DC}} - \frac{{P}_{R}}{2 {ω}_{G} {V}_{DC} {G}_{DC}} sin ( 2 {ω}_{G} t ) , \qquad ( 37 )$$

$$i . e . {V}_{DC , min} \leq {v}_{DC}^{ss} ( t ) \leq {V}_{DC , min} with \qquad ( 38 )$$

$${V}_{DC , min} = \{ \begin{matrix}{V}_{DC}^{*} - {P}_{R} ( \frac{2}{{V}_{GM} K} + \frac{1}{2 {ω}_{G} {V}_{DC} {C}_{DC}} ) , & {P}_{R} \geq 0 \\ {V}_{DC}^{*} - {P}_{R} ( \frac{2}{{V}_{GM} K} - \frac{1}{2 {ω}_{G} {V}_{DC} {C}_{DC}} ) , & {P}_{R} \leq 0\end{matrix} \qquad ( 39 )$$

$${V}_{DC , max} = \{ \begin{matrix}{V}_{DC}^{*} - {P}_{R} ( \frac{2}{{V}_{GM} K} - \frac{1}{2 {ω}_{G} {V}_{DC} {C}_{DC}} ) , & {P}_{R} \geq 0 \\ {V}_{DC}^{*} - {P}_{R} ( \frac{2}{{V}_{GM} K} + \frac{1}{2 {ω}_{G} {V}_{DC} {C}_{DC}} ) , & {P}_{R} \leq 0\end{matrix}$$

### Exemplary Controller Coefficients Derivation

It is generally assumed that grid frequency CO_{G} does not remain constant at a nominal value ω_{G,nom} (to which the notch filter term of (28) is tuned), but varies between two allowed limits (e.g. as described in reference [44]):

$${ω}_{G , min} \leq {ω}_{G} \leq {ω}_{G , max} . \qquad ( 40 )$$

In some embodiments, it is assumed that the DC link voltage loop gain magnitude (29) excluding the notch filter term is monotonically decreasing. Based on this assumption and taking into account (20), it is assumed that the worst expected THDᵢ value corresponds to ω_{G,min}. Denoting a maximum allowed value of grid-side current THD as THD*ᵢ, in some embodiments, a first design equation is:

$$\vert {L}_{V} ( 2 {ω}_{G , min} ) \vert = 2 \cdot {THD}_{i}^{*} = \frac{{V}_{GM} {KG}_{DC}}{4 {ω}_{G , min} \sqrt{1 + 4 {{ξ}^{2} ( \frac{{ω}_{G , nom} {ω}_{G , min}}{{ω}_{G , nom}^{2} - {ω}_{G , min}^{2}} )}^{2}}} . \qquad ( 41 )$$

In some embodiments, it is assumed that, in practice, (31) implies that the crossover frequency is much lower than double-grid frequency (or phase margin in close to 90°). According to (29), actual phase margin is given by

$$PM = \frac{π}{2} - {tan}^{- 1} \frac{4 ξ {ω}_{G , nom} {ω}_{V}}{4 {ω}_{G , nom}^{2} - {ω}_{V}^{2}} \qquad ( 42 )$$

with ω_{V}<2ω_{G,nom} denoting the crossover angular frequency. Hence, in a case where a minimum tolerable phase margin is given by PM*, and using (42):

$${ω}_{V}^{2} + \frac{4 ξ {ω}_{G , nom}}{tan ( \frac{π}{2} - {PM}^{*} )} {ω}_{V} - 4 {ω}_{G , nom}^{2} = 0. \qquad ( 43 )$$

In some embodiments, it is assumed that, the following holds at ω_{V}:

$$\vert {L}_{V} ( {ω}_{V} ) \vert = \frac{\frac{{V}_{GM} {KG}_{DC}}{2 {ω}_{V}} ( 4 {ω}_{G , nom}^{2} - {ω}_{V}^{2} )}{\sqrt{{( 4 {ω}_{G , nom}^{2} - {ω}_{V}^{2} )}^{2} + {( 4 ξ {ω}_{G , nom} {ω}_{V} )}^{2}}} = 1. \qquad ( 44 )$$

In some embodiments, (41), (43) and (44) are a three-equations set with three unknowns (namely K, ξ and ω_{V}), solution of which set yields coefficients of (28) and a resulting crossover frequency.

### Exemplary Boost Pre-Convertor

Considering an exemplary single phase power factor correction boost pre-converter operating off a grid frequency of; 50 Hz, 230 Vrms mains with a possible 1% variation in frequency and a typical value of V*_{DC}=400V.

Assuming a 10 ms hold-up time requirement which imposes C_{DC}/P_{R}=770 μF/kW (e.g. according to reference [45]). Setting PM*=60°, THD*=2.5% and solving (41), (43) and (44) yields:

$$K = 1.02 , ξ = 0.17 , {ω}_{V} = 2 π \cdot 74. \qquad ( 45 )$$

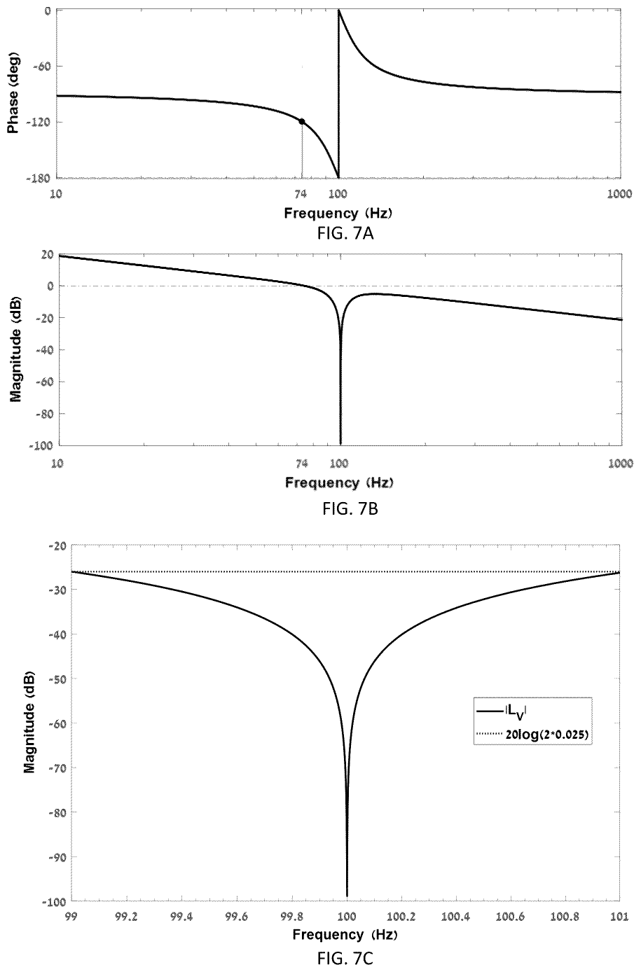

FIG. 7A is a Bode phase plot of phase with frequency for a DC link voltage loop gain, according to some embodiment of the disclosure.

FIG. 7B is a Bode magnitude plot of gain magnitude with frequency for a DC link voltage loop gain, according to some embodiment of the disclosure.

FIG. 7C is an enlarged portion of FIG. 7B showing magnitude for frequencies between 2ω_{G,min}<ω<2ω_{G,max}.

In some embodiments, FIGS. 7A-C illustrate a simulated DC link voltage loop gain Bode diagram e.g. for values indicated in relation (45). Where, in some embodiments, the Bode diagram verifies compliance with PM* and the expected crossover frequency value in (45). Magnitude of L_{V}(s), zoomed around double-grid frequency, is depicted in FIG. 3(b), indicating accurate compliance with THD* e.g. according to (41).

### Exemplary Simulations

Simulations were run for a system response to a 25 W-1025 W-25 W load step for three values of grid frequency, illustrating grid frequency fluctuation around a nominal grid frequency.

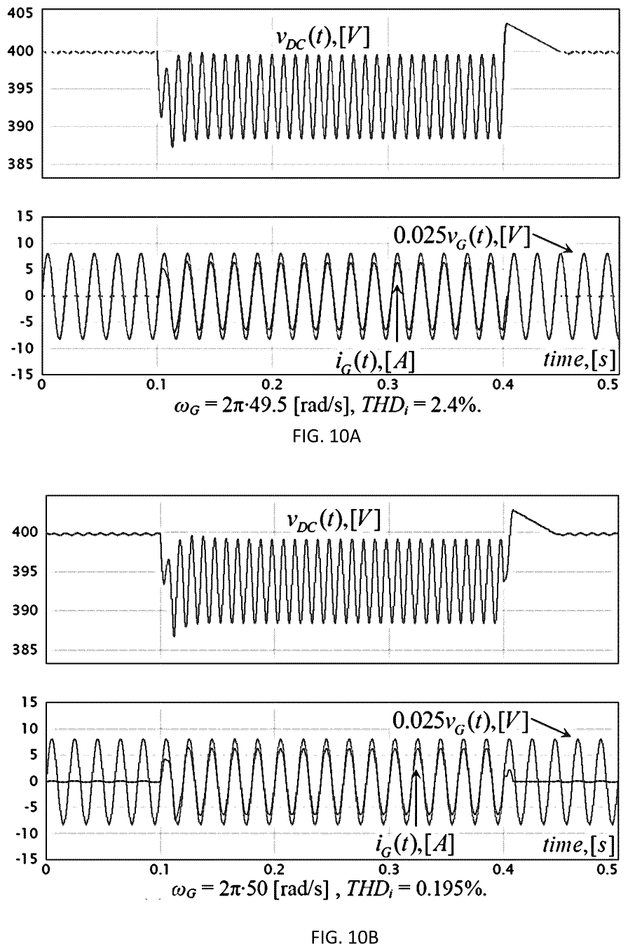

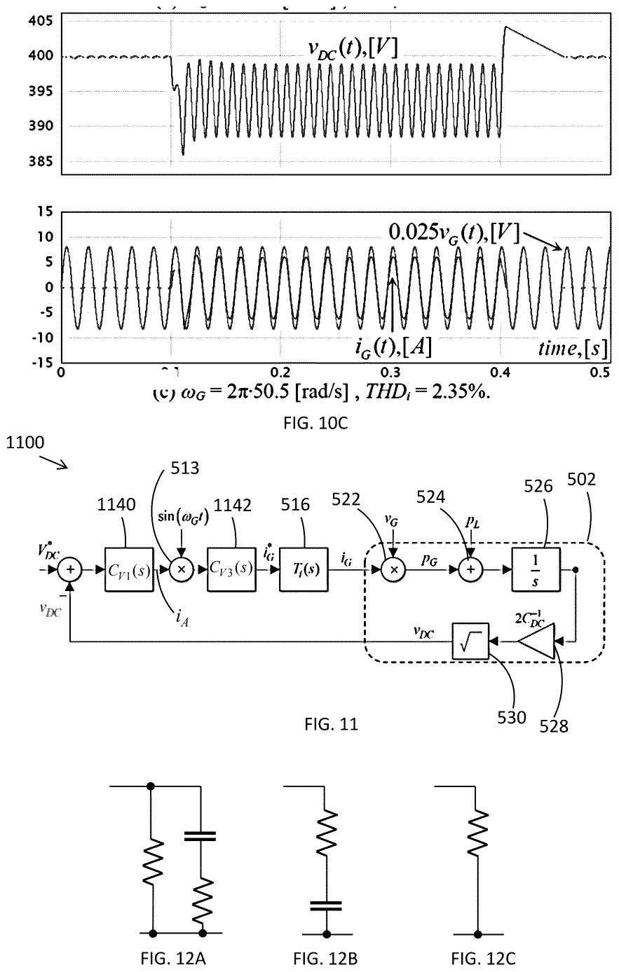

FIG. 10A illustrates a simulated system response to rated load application and removal for a grid frequency of 2π·49.5 [rad/s], according to some embodiments of the disclosure.

FIG. 10B illustrates a simulated system response to rated load application and removal for a grid frequency of 2π·50 [rad/s], according to some embodiments of the disclosure.

FIG. 10C illustrates a simulated system response to rated load application and removal for a grid frequency of 2π·50.5 [rad/s], according to some embodiments of the disclosure.

Results of the simulation are also illustrated in the below table:

| ω_{G} | THDᵢ |
|---|---|
| 2π · 49.5 [rad/s] | 2.4% |
| 2π · 50 [rad/s] | 0.195% |
| 2π · 50.5 [rad/s] | 2.35% |

Simulation results illustrate that grid-side current THD complies with THD* under full loading for all three grid frequencies.

The simulation also showed that the average DC link voltage value reduces to ~394V under full loading, e.g. as predicted by (36).

Simulation showed that, since the right-hand side of (31) is evaluated as 0.58, notch filter term of (28) has some influence on dynamic response, imposing a slight DC link voltage undershoot upon load increase. Nevertheless, steady state limits of the DC link voltage comply well with the values predicted by (39).

### Exemplary Dual Grid Frequency Implementation

In some embodiments, the GIC is a universal GIC e.g. able to support more than one grid frequency. For example, both 50 Hz and 60 Hz grids e.g. where the different grid frequencies have with different values of V_{GM}.

In some embodiments, V_{GM} is measured and used in implementation of the controller.

Alternatively, in some embodiments, the controller is designed (e.g. coefficients selected) according to the worst case of V_{GM} e.g. without control circuitry measuring V_{GM}

In some embodiments, a controller is implemented which takes into account multiple grid frequencies (e.g. both of two possible frequencies e.g. 50 Hz and 60 Hz). Where, in some embodiments, the voltage controller employs a double-notch filter e.g. the voltage controller transfer function having a double notch term.

For example, in some embodiments, a P+Notch² controller suitable for two grid frequencies of interest ω_{G1,nom} and CO_{G2,nom}. For example, by implementing the controller as the transfer function:

$${C}_{V} ( s ) = K \frac{{s}^{2} + 4 {ω}_{G 1 , nom}^{2}}{{s}^{2} + 4 {ξ}_{1} {ω}_{G 1 , nom} s + 4 {ω}_{G 1 , nom}^{2}} \frac{{s}^{2} + 4 {ω}_{G 2 , nom}^{2}}{{s}^{2} + 4 {ξ}_{2} {ω}_{G 2 , nom} s + 4 {ω}_{G 2 , nom}^{2}} . \qquad ( 46 )$$

### Exemplary Convertor Implementations

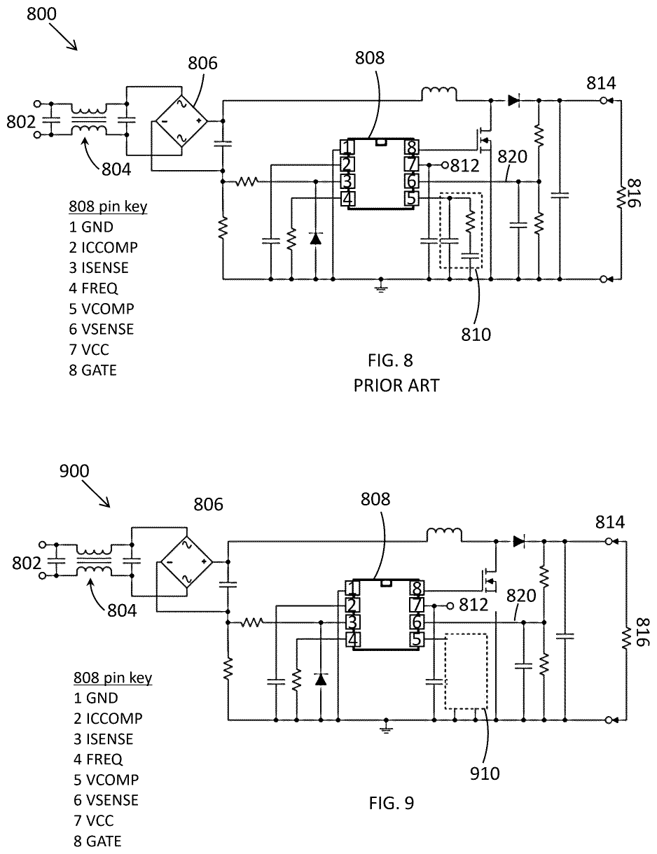

FIG. 8 is a simplified schematic of a grid-connected convertor (GIC) 800, according to some embodiments of the disclosure.

FIG. 9 is a simplified schematic of a grid-connected convertor (GIC) 900, according to some embodiments of the disclosure.

FIG. 9, in some embodiments, illustrates an exemplary implementation, according to some embodiments of this disclosure. FIG. 8, in some embodiments, illustrates a prior art GIC including a type-II voltage controller 810.

FIG. 8 and FIG. 9, in some embodiments, illustrate upgrading of existing convertors, according to some embodiments of the disclosure, where, for example, in some embodiments, FIG. 8 illustrates a convertor prior to an upgrade and FIG. 9 the convertor after the upgrade.

FIG. 8 illustrates a convertor 800 including a power supply 802, a filter (e.g. EMI filter) 804, a rectifier 806 (e.g. bridge rectifier), a PFC IC 808, a type-II regulator 810, an auxiliary supply 812, a voltage output 814 across a load 816 and a DC link 820 voltage feedback to PFC IC 808. Where, in some embodiments, PFC IC 808, at pin 8 provides a voltage for switching of active component 830. Where, in some embodiments, active component is a transistor and pin 8 provides a gate voltage to transistor 830. A key to pins of IC 808 is illustrated in FIG. 8 and FIG. 9. In some embodiments, for example, PFC control IC 808 includes a UCC28180 PFC Control IC from Texas Instruments Inc.

FIG. 9 illustrates an exemplary implementation, where convertor 900 includes a PFC control IC (integrated circuit) 908.

In the implementation illustrated in FIG. 9, in some embodiments, convertor 900 is the same as convertor 800 of FIG. 8, where type-II regulator 810 of FIG. 8 has been replaced by a voltage controller 910 including feature/s of voltage controllers as described elsewhere in this document (controller 910 e.g. including a lead-lag regulator and a notch filter).

FIG. 11 is a simplified schematic block diagram of a power conversion system 1100, according to some embodiments of the disclosure.

Referring back to FIG. 5, in some embodiments, functionality of a portion of voltage controller transfer function C_{V}(s) is transferred to different region/s of a GIC e.g. different than those corresponding to positions illustrated in FIG. 5.

Referring to C_{V}(s) of FIG. 5, the transfer function of the voltage controller, is, in some embodiments, divided into a first C_{V1}(s) and second portion C_{V2}(s):

$${C}_{V} ( s ) = {C}_{V 1} ( s ) \cdot {C}_{V 2} ( s ) \qquad ( 47 )$$

Where, referring now to FIG. 11, first portion C_{V1}(s) is then converted to C_{V3}(s) so that the combination of repositioned first portion C_{V3}(s) and second portion C_{V2}(s) provide the same signal control. Where FIG. 11 illustrates, in some embodiments, where a portion C_{V1}(s) of functionality of C_{V}(s) in FIG. 5 is transferred to the right of multiplier 513 as C_{V3}(s).

In some embodiments, C_{V3}(s) applies notch filter functionality e.g. to a received input signal to provide an outputted signal. In some embodiments, C_{V1}(s) corresponds to one of type-II, lead-lag, PI, and P voltage control.

Where C_{V1}(s) operates on signal V*_{DC}−V_{DC} to provide i_{A}. Where, in some embodiments, i_{A} is multiplied with sin(ω_{G}t). Where the multiplied signal i_{A}·sin(ω_{G}t) is provided to C_{V3}(s) to produce i*_{GM} e.g. which corresponds to i*_{GM} FIG. 5.

For example, referring to a lead-lag+notch controller:

$${C}_{V} ( s ) = {\underbrace{K \frac{τ s + 1}{σ s + 1}}}_{{C}_{V 1} ( s )} \cdot {\frac{{s}^{2} + 4 {ω}_{G}^{2}}{\underbrace{{s}^{2} + 4 {ξω}_{G} s + 4 {ω}_{G}^{2}}}}_{{C}_{V 2} ( s )} = {C}_{V 1} ( s ) \cdot {C}_{V 2} ( s ) . \qquad ( 48 )$$

$${C}_{V 3} ( s ) = \frac{{s}^{2} + 9 {ω}_{G}^{2}}{{s}^{2} + 6 ζ {ω}_{G} s + 9 {ω}_{G}^{2}} \qquad ( 49 )$$

An exemplary implementation of which is illustrated by FIG. 9 where element 910 includes lead-lag circuitry, and where PFC control IC 908 performs notch filtering (CV₃(s)). Exemplary lead-lag circuitry is illustrated in FIG. 11A.

In some embodiments, the ability to provide notch filtering at the PFC control IC is used to convert an existing GIC into the same type, but with notch filtering. For example, referring to FIG. 8, C_{V3}(s), in some embodiments, is implemented in PFC control IC 808 e.g. to provide a type-II+notch controller. For example, referring back to FIG. 2. In some embodiments, system 200 lacks notch filter 206, notch filter functionality being provided by PFC controller 212. Alternatively, notch filter 206 is implemented between PFC controller 212 and current controller 216.

In some embodiments, C_{V3}(s) provides additional functionality than that of notch filtering. For example, in some embodiments, referring back to FIG. 8, type-II controller 810, in some embodiments, is transformed into a lead-lag+notch controller by selection of an appropriate C_{V3}(s) (corresponding to an appropriate C_{V1}(s)) which, in some embodiments, is implemented at PFC control IC 808. Where, for example, in this case:

$${C}_{V 2} ( s ) = \frac{{s}^{2} + 4 {ω}_{G}^{2}}{s ( {s}^{2} + 4 ζ {ω}_{G} s + 4 {ω}_{G}^{2} )}$$

FIGS. 12A-C are simplified schematic illustrations of type-II, PI and P voltage control circuitry, respectively, according to some embodiments of the disclosure.

Referring now to FIG. 9, in some embodiments, one or more of a P+lead-lag+notch, a P+notch, and a PI+notch voltage controller are implemented by providing notch filter processing at the PFC control IC 908 and the corresponding lead-lag, P, or PI circuitry at 910. Where, FIGS. 11A-C, in some embodiments, respectively illustrate exemplary lead-lag, P, and PI circuitry for incorporation, in some embodiments, at 910.

### General

It is expected that during the life of a patent maturing from this application many power factor controllers will be developed and the scope of the term power factor controller is intended to include all such new technologies.

As used within this document, the term “about” refers to ±20%

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the invention. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g. for clarity) described in the context of separate embodiments, may also be provided in combination in a single embodiment. Where various features of the invention, which are (e.g. for brevity) described in a context of a single embodiment, may also be provided separately or in any suitable sub-combination or may be suitable for use with any other described embodiment. Features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, this application intends to embrace all such alternatives, modifications and variations that fall within the spirit and broad scope of the appended claims.

All references (e.g. publications, patents, patent applications) mentioned in this specification are herein incorporated in their entirety by reference into the specification, e.g. as if each individual publication, patent or patent application was individually indicated to be incorporated herein by reference. Citation or identification of any reference in this application should not be construed as an admission that such reference is available as prior art to the present invention. In addition, any priority document(s) and/or documents related to this application (e.g. co-filed) are hereby incorporated herein by reference in its/their entirety.

Where section headings are used in this document, they should not be construed as necessarily limiting.

1. A grid-connected converter comprising a power factor controller (PFC) for control of flow of power from a grid supply to a load via a DC link, by switching of at least one active component, which converter comprising:
a voltage controller receiving a link voltage v_{DC} at said DC link and generating a feedback control signal for input to PFC controller from said link voltage, which voltage controller comprising:
a notch filter tuned to a nominal grid frequency; and
a proportional (P)+lead lag compensator.

2. The grid-connected converter according to claim 1, wherein coefficients of said notch filter and said P+lead lag compensator are selected to provide a selected total harmonic distortion (THD) of said grid supply.

3. The grid-connected converter according to claim 2, wherein said coefficients are selected to provide said THD for a range of grid frequencies around said nominal grid frequency.

4. The grid-connected convertor according to claim 1, wherein a frequency domain transfer function of said P+lead lag compensator includes a pole and a zero.

5. The grid-connected converter according to claim 4, wherein said voltage controller is implemented according to a voltage controller transfer function, C_{V}(s):
$${C}_{V} ( s ) = K \frac{τ s + 1}{σ s + 1} \frac{{s}^{2} + 4 {ω}_{G}^{2}}{{s}^{2} + 4 {ξω}_{G} s + 4 {ω}_{G}^{2}}$$
where ω_{G} is said grid frequency, K is a constant for proportional control and K, ξ, and σ are selected to control total harmonic distortion (THD) of a grid power supply.

6. The grid-connected convertor according to claim 4, wherein
said pole is located at the origin, K is non-zero, said compensator providing a proportional control term to said frequency domain transfer function.

7. The grid-connected converter according to claim 6, wherein said controller is implemented, according to a controller transfer function, C_{V}(s):
$${C}_{V} ( s ) = K \frac{{s}^{2} + 4 {ω}_{G}^{2}}{{s}^{2} + 4 ξ {ω}_{G} s + 4 {ω}_{G}^{2}}$$
where ω_{G} is said grid frequency, K is a constant for proportional control and K and ξ are selected to control total harmonic distortion (THD) of a grid power supply.

8. The grid-connected converter according to claim 1, comprising a current controller which receives a signal i_{GM}* from said PFC controller and uses said signal from said PFC controller as a reference current to generate a control signal for switching of said at least one active component.

9. The grid-connected convertor according to claim 8, comprising a pulse width modulator (PWM) which receives said control signal from said current controller and generates a drive signal for switching of said at least one active component.

10. The voltage controller according to claim 1, wherein said link voltage is a voltage across a bulk DC link capacitance linking said convertor to a load.

11. The grid-connected converter according to claim 10, wherein an input to said voltage controller comprises a difference between said DC link voltage and a reference voltage.

12. The grid connected converter according to claim 1, comprising an additional notch filter tuned to an additional nominal grid frequency.

13. The grid connected converter according to claim 12, wherein said nominal grid frequency is 50 Hz and said additionally nominal grid frequency is 60 Hz.

14. The grid connected convertor according to claim 12, wherein said controller is implemented, according to a controller transfer function, C_{V}(s):
$${C}_{V} ( s ) = K \frac{{s}^{2} + 4 {ω}_{G 1 , nom}^{2}}{{s}^{2} + 4 {ξ}_{1} {ω}_{G 1 , nom} s + 4 {ω}_{G 1 , nom}^{2}} \frac{{s}^{2} + 4 {ω}_{G 2 , nom}^{2}}{{s}^{2} + 4 {ξ}_{2} {ω}_{G 2 , nom} s + 4 {ω}_{G 2 , nom}^{2}} .$$

15. The grid-connected converter according to claim 5, wherein said K and said are selected to maintain said THD below a maximum allowed total harmonic distortion (THDᵢ*) and a minimum allowed phase margin (PM*).

16. The grid-connected converter according to claim 11,
wherein said grid frequency (ω_{G}) varies between two limits ω_{G,min}≤ω_{G}≤ω_{G,max}; and
wherein K and ξ are determined using design equations:
$$2 {THD}_{i}^{*} = \frac{{V}_{GM} {KG}_{DC}}{4 {ω}_{G , min} \sqrt{1 + 4 {ξ}^{2} {( \frac{{ω}_{G} {ω}_{G , min}}{{ω}_{G}^{2} - {ω}_{G , min}^{2}} )}^{2}}} ;$$
$${ω}_{V}^{2} + \frac{4 ξ {ω}_{G , nom}}{tan ( \frac{π}{2} - {PM}^{*} )} {ω}_{V} - 4 {ω}_{G , nom}^{2} = 0 ; and$$
$$\frac{\frac{{V}_{GM} {KG}_{DC}}{2 {ω}_{V}} ( 4 {ω}_{G}^{2} - {ω}_{V}^{2} )}{\sqrt{{( 4 {ω}_{G}^{2} - {ω}_{V}^{2} )}^{2} + {( 4 {ξω}_{G} {ω}_{V} )}^{2}}} = 1 ;$$
where ω_{V} is cross over angular frequency;
where V_{GM} is a steady state value of grid side input voltage; and
where
$${G}_{DC} = \frac{1}{{C}_{DC} {V}_{DC}^{*}}$$
where C_{DC} is a capacitance of said bulk link capacitor and V*_{DC} is said reference voltage.

17. A system comprising a grid-connected converter according to claim 1, comprising a load interfacing convertor (LIC) connected between said DC link capacitance and said load.

18. The system according to claim 17, wherein said load interfacing convertor is a DC-DC convertor.

19.-20. (canceled)

21. A method of upgrading a grid-connected convertor connectable to a load by a DC link and having a PFC controller comprising:
adjusting an original voltage controller to include:
a notch filter tuned to a nominal grid frequency; and
a lead lag compensator.

22. The method according to claim 21, wherein said adjusting comprises one or more of:
removing said original voltage controller and replacing said original voltage controller with a controller comprising said notch filter and said lead lag compensator;
adjusting software of a digitally implemented voltage controller; and
adding and/or replacing and/or removing passive circuit components.

23.-32. (canceled)
